(19) United States
(12) Patent Application Publication
(10) Pub. No.: US 2013/0152201 A1
(43) Pub. Date: Jun. 13, 2013

(54) Adjunct Computing Machine for Remediating Malware on Compromised Computing Machine

(71) Applicants: Vincent P. Gullotto, Kirkland, WA (US); Kelsey Scott Molenkamp, Melbourne (AU); Marc E. Seinfeld, Fort Lauderdale, FL (US); Chengi Jimmy Kuo, Manhattan Beach, CA (US)

(72) Inventors: Vincent P. Gullotto, Kirkland, WA (US); Kelsey Scott Molenkamp, Melbourne (AU); Marc E. Seinfeld, Fort Lauderdale, FL (US); Chengi Jimmy Kuo, Manhattan Beach, CA (US)

(73) Assignee: MICROSOFT CORPORATION, Redmond, WA (US)

(21) Appl. No.: 13/316,709

(22) Filed: Dec. 12, 2011

(51) Int. Cl. G06F 21/00

(52) U.S. Cl. 726/24

(57) ABSTRACT

Described is a technology by which a malware-compromised machine, such as a personal computer is cleaned through the use of a functional adjunct machine, such as a mobile device (or vice-versa). The functional adjunct machine performs actions on behalf of the malware-compromised machine and/or to assist the remediation. This may include downloading antimalware-related data (e.g., an application, antimalware code, signature updates and/or the like) via a marketplace/application store, and transferring at least some of the data and/or programs to the compromised machine. Other actions may include using the functional adjunct machine to boot the malware-compromised machine into a non-compromised state and providing the data or programs to allow remediation of the malware while in this state.

### BACKGROUND

Computing machines including personal computers, tablet devices and other devices such as smartphones and network-capable televisions are susceptible to malware infections, including various threats such as computer viruses. In addition to viruses, another type of threat is rogue software, in which a malicious program is loaded onto a computing machine, typically via a malicious website that a user was tricked into visiting. The rogue software is then able to take control of at least part of a user's machine. Often the rogue program extorts/defrauds users out of money by offering to fix the problems it caused, by purchasing security software.

As part of controlling the malware-compromised computing machine, contemporary threats are typically able to actively disable product update capabilities. For example, rogue software can render the machine's web browser helpless (or explicitly block access to certain sites), whereby the user is unable to access desired websites, including product update websites. This generally includes websites that have the ability to remediate the threat via antimalware software installation and/or antimalware signature updates. Thus, for a software vendor, a significant, costly and time-consuming support issue when dealing with customers attempting to remediate such infections is the inability to configure an infected machine with antimalware software, or to update existing antimalware software and/or signatures on an infected machine.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a functional adjunct computing machine (or more simply “functional machine,” “functional adjunct machine” or “adjunct machine”) obtains antimalware-related data, and transfers at least part of the antimalware-related data to a malware-compromised computing machine (or more simply “compromised machine”) for use in remediating malware on the compromised machine. For example, the functional adjunct machine may be a smartphone and the malware-compromised machine may be a personal computer, or vice-versa. The antimalware-related data may be obtained by downloading an application from a marketplace or application store.

In one aspect, the antimalware-related data includes antimalware code, which the compromised machine executes to scan and remediate the malware on the compromised machine to transform the compromised machine into a clean machine. In one aspect, the transferred antimalware-related data from the adjunct machine is used to update signatures on the malware-compromised machine. In this way, a partially disabled compromised machine is able to execute code and/or get updates.

In one aspect, the malware-compromised machine may be compromised by having malware in a storage mechanism thereof. The compromised machine may be booted from the clean adjunct machine, in order to operate the compromised machine in a non-compromised operational state. While in the non-compromised operational state, the antimalware-related data is transferred to the compromised machine, including loading antimalware code for execution, to scan and remediate the malware on the compromised machine. The up-to-date antimalware, running in a clean environment, can inspect, detect and remediate the infected storage and associated operating system configuration. This cleans the storage mechanism and transforms the malware-compromised machine to a clean machine. The clean machine is rebooted from the cleaned storage and operating system mechanism (e.g., instead of from the functional adjunct machine) after the storage mechanism is cleaned.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a functional adjunct machine and a malware-compromised machine in which the functional adjunct machine obtains antimalware data on behalf of the compromised machine, according to one example implementation.

FIG. 2 is a flow diagram representing example steps that may be taken by the functional adjunct machine and malware-compromised machine to remediate malware based upon the example implementation of FIG. 1.

FIG. 3 is a block diagram showing example components of a functional adjunct machine and a malware-compromised machine in which the functional adjunct machine provides antimalware data, including executable antimalware code, to the compromised machine, according to one example implementation.

FIG. 4 is a flow diagram representing example steps that may be taken by the functional adjunct machine and malware-compromised machine to remediate malware based upon the example implementation of FIG. 3.

FIG. 5 is a block diagram showing example components of a functional adjunct machine and a malware-compromised machine in which the functional adjunct machine is used to boot the malware-compromised machine into an operational state that is offline with respect to running malware, according to one example implementation.

FIG. 6 is a flow diagram representing example steps that may be taken by the functional adjunct machine and malware-compromised machine to remediate malware based upon the example implementation of FIG. 5.

FIG. 7 is a block diagram representing an example computing environment, in the form of a mobile device, into which aspects of the subject matter described herein may be incorporated.

FIG. 8 is a block diagram representing an example computing environment, including a computer system, into which aspects of the subject matter described herein may be incorporated.

### DETAILED DESCRIPTION

Various aspects of the technology described herein are generally directed towards using one computing machine, such as a personal computer, and another computing machine, such as a mobile machine, as an adjunct with respect to remediating (cleaning/removing) malware from the other when its resources are compromised in some way (e.g., infected and disabled or of reduced capacity). In the event one computing machine is compromised, the functional adjunct computing machine is able to access and/or use updated security technologies (e.g., a tool, signatures, and so forth) to facilitate scanning, detecting and remediating the malware on the compromised machine.

In one aspect, the functional adjunct machine may be used actively or partially actively to assist the compromised machine. For example, a partially active adjunct machine may automatically download and copy updated security technologies on behalf of the compromised machine, which the compromised machine may then use to remediate the malware. Alternatively, a more active adjunct may scan the compromised machine and remediate the malware that is detected. This may be by having the functional adjunct machine run a program that scans the drive (and memory) of the compromised machine, or by booting the compromised machine from the adjunct machine, whereby the compromised is scanned in an “offline” state with respect to running the malware. A combined active and passive solution may be used, e.g., the adjunct may scan and remediate the compromised machine until the compromised machine achieves a state in which it is able to take over scanning and remediation.

It should be noted that any or all of the antimalware components may be obtained by the adjunct machine by downloading into storage or by having the antimalware code and/or data streamed through the adjunct machine for use in remediating the compromised machine. Thus, as used herein with respect to antimalware, “obtain” and its derivatives (e.g., “obtaining”) refers to any antimalware component or components for storing, streaming and/or a combination thereof.

It should be understood that any of the examples herein are non-limiting. For example, while a smartphone is exemplified as a likely functional adjunct machine and a personal computer as a likely compromised machine, the technology may work with multiple personal computers, gaming systems, personal computers, other handheld devices, tablets and so forth. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and computer security in general.

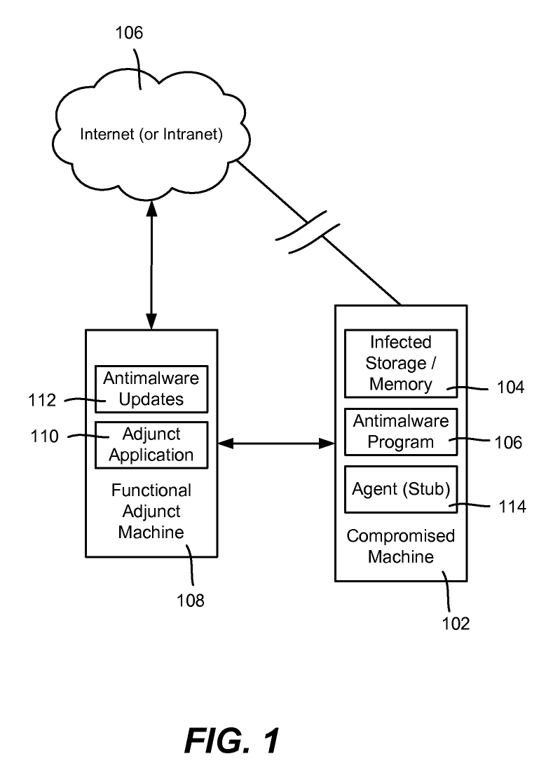

FIG. 1 shows an implementation in which a compromised computing machine 102 containing infected storage/memory 104 is exemplified as being unable to connect to the internet 106 or other suitable network such as an intranet, at least to some extent. For example, rogue malware may prevent the compromised machine 102 from downloading signature updates needed by an antimalware program to remediate that malware, typically by blocking network access; (however limited Internet access may be allowed to purchase a malware solution, e.g., as part of an extortion plot by the malicious entity whose program infected the machine). Such a solution may be temporary, may fail and simply not be acceptable to many users, who then typically call support, e.g., of the operating system vendor.

In the implementation of FIG. 1, a functional adjunct machine 108 is available to the user. For example, many users, even relatively unsophisticated computer users, have access to a smartphone and understand how to access the phone vendor's marketplace/application store to download programs. When a user calls support to find out how to fix a malware problem that is known as having disabled the compromised machine in some way, the support staff personnel inquires as to whether the user has such an adjunct device. If so, support instructs the user to download antimalware-related data in the form of a program (shown in FIG. 1 as the adjunct application 110) from the marketplace onto his or her adjunct machine 108. Alternatively, a user may know in another way (e.g., from a friend, past experience, browsing via another device and so forth) that a solution is available from the marketplace. In any event, in conjunction with the downloading/instructions, the user also couples the adjunct machine 108 to the compromised machine 102 (if not already coupled); the adjunct application 110 may guide the user in this regard. For example, a typical coupling from a smartphone to a personal computer is via a USB connection or Bluetooth® connection.

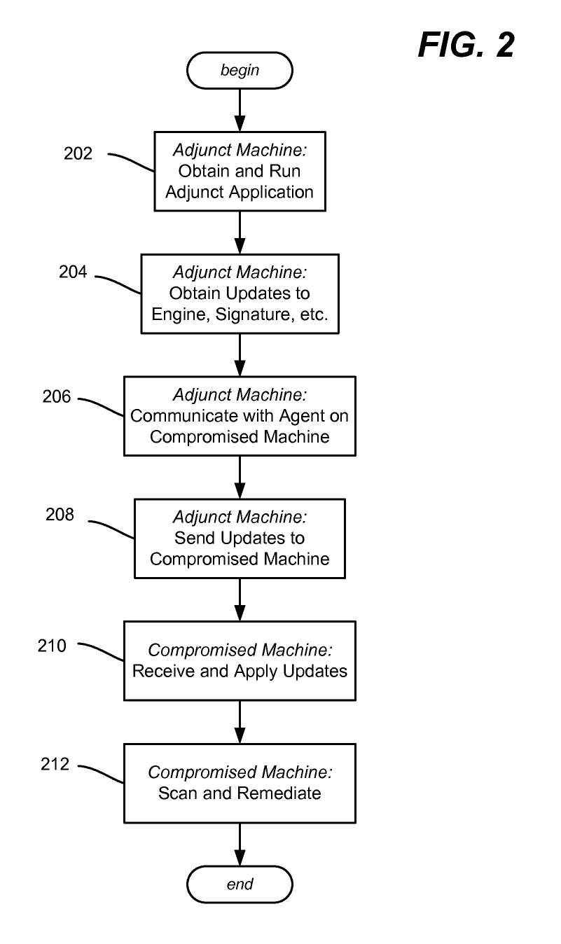

When the user downloads and runs the adjunct application 110 on the adjunct machine, the adjunct application 110 is able to remediate the compromised machine by taking various alternative actions, as exemplified in FIGS. 1-6 and described herein. In the example of FIGS. 1 and 2, the adjunct application 110 actively downloads (or the application includes) additional antimalware-related data (e.g., antimalware updates 112) on behalf of the compromised machine 102, and communicates with an agent (stub) 114 on the compromised machine 102 to send a copy of the updates 112 to the compromised machine 102. Thus, the compromised machine 102 is able to obtain the antimalware updates even without a functional Internet connection. Note that the agent/stub 114 may be affiliated with the antimalware program 106 on the compromised machine, or may be an application, operating system component or service loaded onto the machine in anticipation of the possibility that the machine may one day encounter malware. In addition to signature updates, the agent/stub 114 may be configured to install or update the antimalware program 106 as needed on the compromised machine 102. The antimalware program 106 may then remediate the malware.

FIG. 2 summarizes the steps of each machine, beginning at step 202 where the adjunct machine obtains and runs the adjunct application. At step 204, the application on the adjunct machine obtains the signature and/or engine updates. The updates are then communicated to the compromised machine's agent/stub via steps 206 and 208.

Step 210 represents the compromised machine receiving and applying the updates, which are then used at step 212 to scan and remediate the machine. As can be readily appreciated, most of the process is automated, as the user has not done anything complicated to remediate the problem, other than to download the adjunct application and run it, which is very easy, fast and efficient for support personnel to explain to a user. This implementation leverages the customers' growing familiarity with a marketplace/application store, and accessing the internet via a tightly coupled mobile and marketplace/application store, to facilitate downloading/updating a current version of a cleaner tool and/or signatures. The user may have to answer certain questions, e.g., what operating system is being used, whether an antimalware program is already installed and so forth, however these are relatively straightforward. Moreover, the agent/stub 114 may have be configured with knowledge of this and other (e.g., version) information, which it can return to the adjunct application 110 so the user or automated mechanism can obtain it from the adjunct machine 108 in the event such additional information is needed by support personnel.

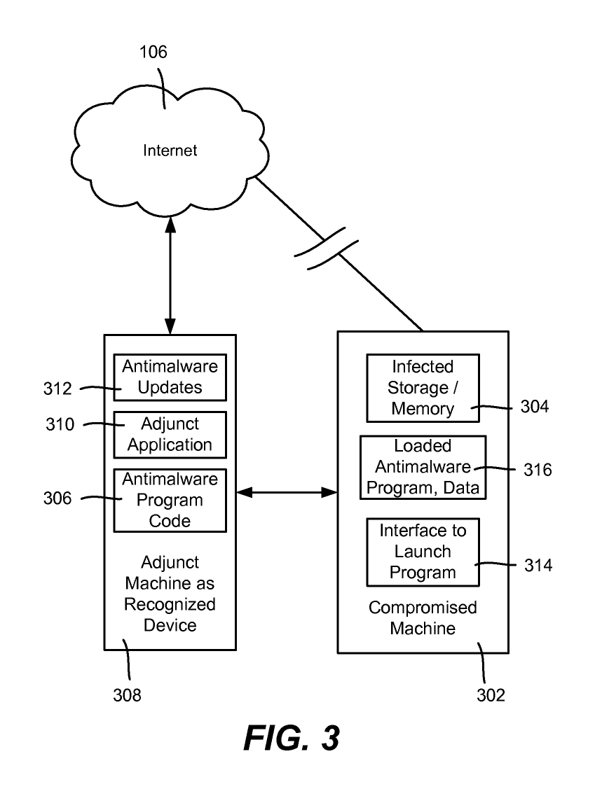

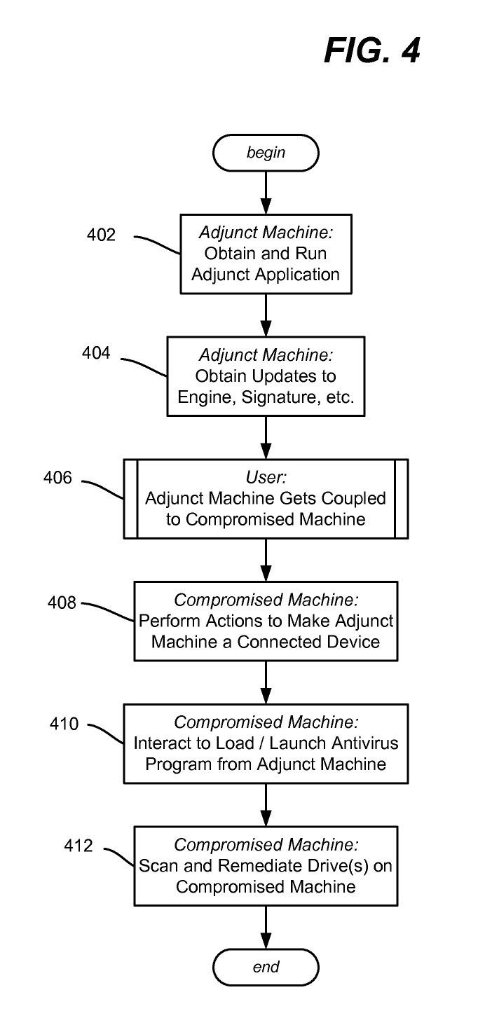

FIGS. 3 and 4 are examples of an alternative implementation, in which an adjunct machine 308 executes antimalware program code 306 such as a scanning/cleaning tool (e.g., Microsoft Corporation's Malicious Software Removal Tool (MSRT) or Microsoft Corporation's Microsoft Security Essentials Alert Removal Tool (MSERT)) that process a compromised device's storage and memory 304 to remove viruses, spyware, and other malicious software. For example, this implementation may be needed when the malware has prevented the antimalware program on the compromised machine from running and/or being reinstalled, such as by corrupting its code, intercepting its function calls, and/or the like. Similarly, the agent/stub may be disabled by a more sophisticated attack. In general, the compromised machine (e.g., a personal computer) runs the tool from the adjunct device's storage, memory and operating system so as to scan, detect and disinfect the compromised machine's storage including files and configuration data.

The adjunct machine 308 may download an adjunct application 310, which obtains updates 312 and adjunct antimalware program code 306 as needed, e.g., from an application marketplace as described above; (the antimalware program code 306 may be incorporated into the adjunct application 310). Support personnel may recognize when more than a signature update is needed to remediate an infection, for example, and instruct the user to download a different adjunct application.

In this example, the user is able to scan the infected storage/memory of the compromised machine via the antimalware program code 306 on the adjunct machine 308. One way is to use the functional adjunct machine as an alternate storage device from which a program may be launched, (or vice-versa). An appropriate handshake and protocol between the machines may be used, e.g., a manifest of machine personalization (updated applications, code and data and/or locations for a customized on-demand scan) may be exchanged as part of a procedure for one machine's scanner to configure and initiate the scan, with knowledge of the machines' readiness for the scan given the handshake and data exchange.

By way of example, when connected, the compromised machine may be able to view the adjunct machine as a recognized device, as is typical for many types of devices when coupled to a personal computer, for example. For example, the adjunct machine may automatically appear on an interface 314 as a file system volume (portable hard disk drive) such as E:\, or as a device accessible through its corresponding application, with which the user may interact to locate, load and launch an instance of the antimalware program 306 and/or a signature update package, shown in FIG. 3 via the loaded program and related data 316 (e.g., the tool/engine and signatures).

When run, the loaded program and related data 316 in the compromised machine's memory is executed by the compromised machine's CPU. This action scans the storage and memory 304 of the compromised machine 302, and thereby remediates the malware. Thus, a compromised machine that cannot run its own antimalware program, for example, may be cleaned by loading an instance of the adjunct machine's program code.

FIG. 4 summarizes the steps of each machine in this alternative implementation, beginning at step 402 where the functional adjunct machine obtains and runs the adjunct application. At step 404, the application on the functional adjunct machine obtains the antimalware program code (if not already present) and any signature and/or engine updates.

Step 406 represents coupling the adjunct machine to the compromised machine, if not already done, via any wireless or wired means, such as USB. When coupled, in this example the compromised machine performs actions (step 408) that make the adjunct machine a connected device, such as loading drivers via plug-and-play, and/or launching a program with which the user may interact to interface with the device. The user may manually launch such a program if needed.

Step 410 represents the compromised machine program receiving user interaction that loads the antimalware program code from the adjunct machine and launches the program. The antimalware program then runs and scans the compromised machine's memory and drives (step 412), as well as any other drives selected by the user.

As another example, consider that the compromised machine is the one that appears as a storage device of the functional adjunct machine. In this event, the infected storage may be scanned cleaned as any other storage device.

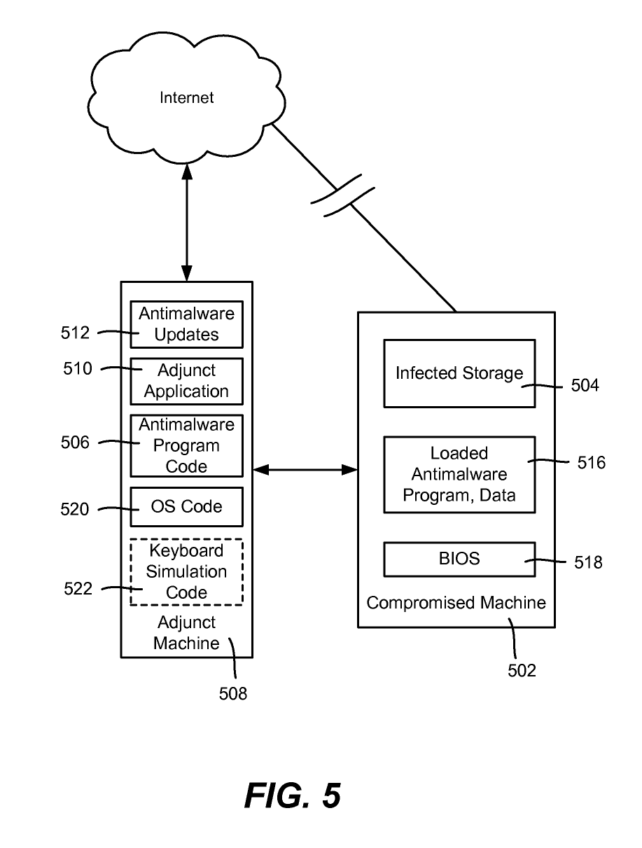

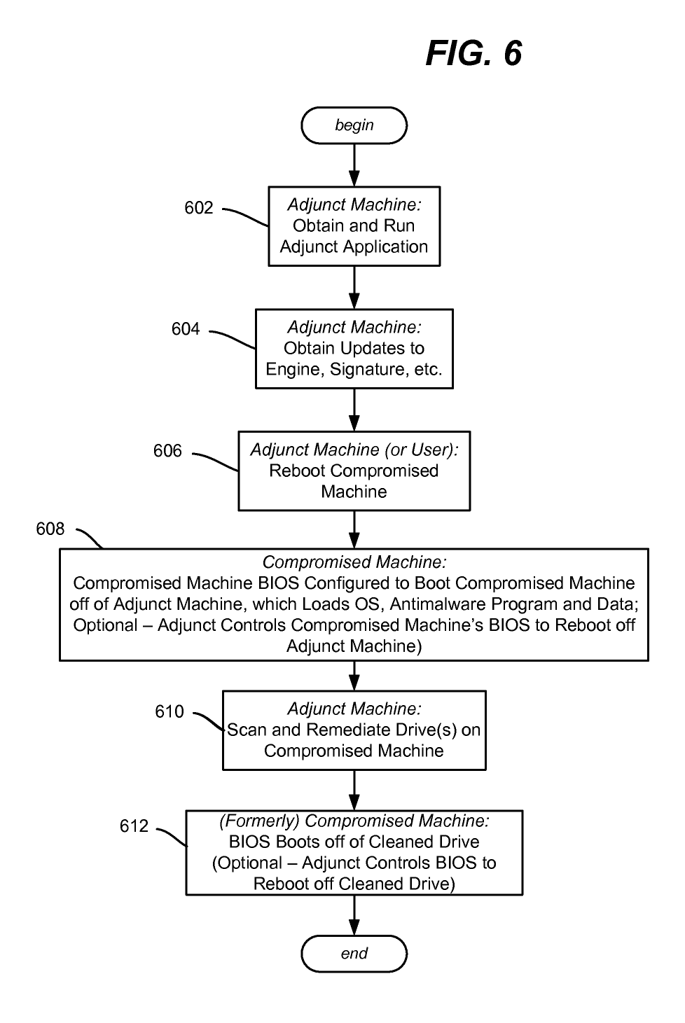

In another alternative implementation generally represented in FIGS. 5 and 6, the adjunct machine is used to download and host the booting of a clean-boot technology (e.g., Microsoft Corporation's standalone system sweeper, http://connect.microsoft.com/systemsweeper) on behalf of the compromised machine. The booting is done by the compromised device, at which point the machine may scan its compromised hard drive. This may be used, for example, when the compromised machine is entirely or significantly disabled, e.g., cannot take action to participate in the remediation process without a clean boot.

More particularly, the compromised machine BIOS 518 is configured to clean boot from the functional adjunct machine 508 and load bootable operating system code 520, as if the adjunct machine was a bootable storage (e.g., a USB thumb drive). The operating system has sufficient functionality (or runs a small program) to acquire, from the adjunct machine 508, antimalware program code 506 (e.g., a cleaner tool) and downloaded updates 512 (e.g., signatures), shown on the compromised machine 502 as loaded antimalware program and data 516. This code is then run to clean the infected storage 504.

As described above, an adjunct application 510 may be downloaded and run to obtain the operations system code 520, the antimalware program code 506 and the updates 512. This removes the need for the user to locate the appropriate combination of items and configure the adjunct machine for booting.

Moreover, as represented in FIG. 5, the adjunct machine 508 may be configured with an additional feature comprising input device (e.g., keyboard) simulation code 522. In general, a connected USB device, for example, can inform the machine to which it is connected that it is an input device such as a keyboard, at least temporarily. More particularly, because the adjunct machine is programmable to act intelligently, and connects as a USB device, the adjunct machine can intelligently emulate any number of devices. The compromised machine sends signals to its USB port, where the adjunct machine can respond to these signals as anything the adjunct machine wants to emulate; an adjunct machine can portray itself as a keyboard, as well as another device at the same time (for instance, a pointing device/mouse and external storage device). As a result, the adjunct machine has the ability to not only send keystrokes to the infected machine, but also access itself as a storage device for the compromised machine (e.g., because it holds the latest signature updates or the whole antimalware package), whereby the adjunct machine may be preprogrammed to simulate or otherwise handle any aspect of human interaction for the process.

For example, upon restarting of the compromised machine 502, the keyboard simulation code 522 may output one or more keystrokes to switch the machine to the BIOS setup user interface, where the user may interact to configure the compromised machine's boot sequence to boot from the adjunct device (boot from USB). The keyboard simulation code 522 may also output at least some of the keystrokes to assist the user in doing this reconfiguration.

FIG. 6 summarizes example steps of the clean adjunct boot implementation, beginning at step 602 where the functional adjunct machine obtains and runs the adjunct application. At step 604, the application on the functional adjunct machine obtains the operating system code, antimalware program, and signature and/or engine updates, as needed. The adjunct machine (e.g., if configured to simulate a keyboard) or the user reboots the compromised machine at step 606.

At step 608, the adjunct machine begins the reboot process, with the BIOS configured to boot off of the adjunct machine. As described above, the adjunct machine may participate in the reconfiguration of the boot sequence by simulating a keyboard, for example. In any event, the BIOS boots off of the adjunct machine, whereby a clean operating system is loaded, along with the antimalware program/data, with the program then launched.

Step 610 represents the compromised machine (now running a clean operating system and code) executing the antimalware program to scan the compromised machine's infected drive (step 412), as well as any other drives as appropriate. This remediates the malware. When scanning and remediation are complete, the formerly compromised machine is rebooted off of the cleaned drive. Note that as described above, the adjunct machine may participate in the rebooting and reconfiguration of the BIOS boot sequence by simulating a keyboard to an extent.

### Example Operating Environment

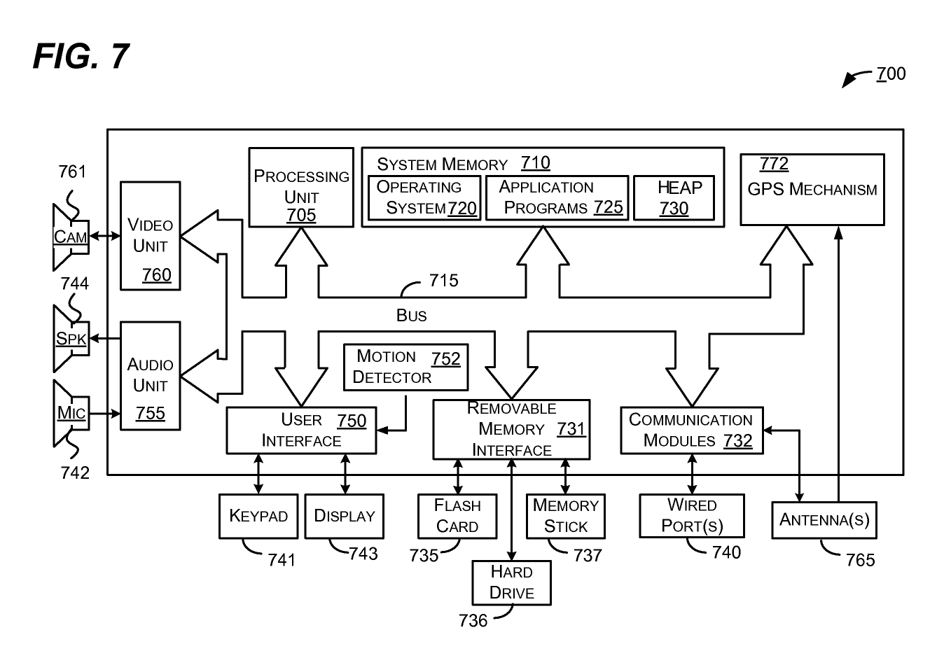

FIG. 7 illustrates an example of a suitable mobile device 700 on which aspects of the subject matter described herein may be implemented. The mobile device 700 is only one example of a device and is not intended to suggest any limitation as to the scope of use or functionality of aspects of the subject matter described herein. Neither should the mobile device 700 be interpreted as having any dependency or requirement relating to any one or combination of components illustrated in the example mobile device 700.

With reference to FIG. 7, an example device for implementing aspects of the subject matter described herein includes a mobile device 700. In some embodiments, the mobile device 700 comprises a cell phone, a handheld device that allows voice communications with others, some other voice communications device, or the like. In these embodiments, the mobile device 700 may be equipped with a camera for taking pictures, although this may not be required in other embodiments. In other embodiments, the mobile device 700 may comprise a personal digital assistant (PDA), hand-held gaming device, notebook computer, printer, appliance including a set-top, media center, or other appliance, other mobile devices, or the like. In yet other embodiments, the mobile device 700 may comprise devices that are generally considered non-mobile such as personal computers, servers, or the like.

Components of the mobile device 700 may include, but are not limited to, a processing unit 705, system memory 710, and a bus 715 that couples various system components including the system memory 710 to the processing unit 705. The bus 715 may include any of several types of bus structures including a memory bus, memory controller, a peripheral bus, and a local bus using any of a variety of bus architectures, and the like. The bus 715 allows data to be transmitted between various components of the mobile device 700.

The mobile device 700 may include a variety of computer-readable media. Computer-readable media can be any available media that can be accessed by the mobile device 700 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 700.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, WiFi, WiMAX, and other wireless media. Combinations of any of the above should also be included within the scope of computer-readable media.

The system memory 710 includes computer storage media in the form of volatile and/or nonvolatile memory and may include read only memory (ROM) and random access memory (RAM). On a mobile device such as a cell phone, operating system code 720 is sometimes included in ROM although, in other embodiments, this is not required. Similarly, application programs 725 are often placed in RAM although again, in other embodiments, application programs may be placed in ROM or in other computer-readable memory. The heap 730 provides memory for state associated with the operating system 720 and the application programs 725. For example, the operating system 720 and application programs 725 may store variables and data structures in the heap 730 during their operations.

The mobile device 700 may also include other removable/non-removable, volatile/nonvolatile memory. By way of example, FIG. 7 illustrates a flash card 735, a hard disk drive 736, and a memory stick 737. The hard disk drive 736 may be miniaturized to fit in a memory slot, for example. The mobile device 700 may interface with these types of non-volatile removable memory via a removable memory interface 731, or may be connected via a universal serial bus (USB), IEEE bus, one or more of the wired port(s) 740, or antenna(s) 765. In these embodiments, the removable memory devices 735-737 may interface with the mobile device via the communications module(s) 732. In some embodiments, not all of these types of memory may be included on a single mobile device. In other embodiments, one or more of these and other types of removable memory may be included on a single mobile device.

In some embodiments, the hard disk drive 736 may be connected in such a way as to be more permanently attached to the mobile device 700. For example, the hard disk drive 736 may be connected to an interface such as parallel advanced technology attachment (PATA), serial advanced technology attachment (SATA) or otherwise, which may be connected to the bus 715. In such embodiments, removing the hard drive may involve removing a cover of the mobile device 700 and removing screws or other fasteners that connect the hard drive 736 to support structures within the mobile device 700.

The removable memory devices 735-737 and their associated computer storage media, discussed above and illustrated in FIG. 7, provide storage of computer-readable instructions, program modules, data structures, and other data for the mobile device 700. For example, the removable memory device or devices 735-737 may store images taken by the mobile device 700, voice recordings, contact information, programs, data for the programs and so forth.

A user may enter commands and information into the mobile device 700 through input devices such as a key pad 741 and the microphone 742. In some embodiments, the display 743 may be touch-sensitive screen and may allow a user to enter commands and information thereon. The key pad 741 and display 743 may be connected to the processing unit 705 through a user input interface 750 that is coupled to the bus 715, but may also be connected by other interface and bus structures, such as the communications module(s) 732 and wired port(s) 740. Motion detection 752 can be used to determine gestures made with the device 700.

A user may communicate with other users via speaking into the microphone 742 and via text messages that are entered on the key pad 741 or a touch sensitive display 743, for example. The audio unit 755 may provide electrical signals to drive the speaker 744 as well as receive and digitize audio signals received from the microphone 742.

The mobile device 700 may include a video unit 760 that provides signals to drive a camera 761. The video unit 760 may also receive images obtained by the camera 761 and provide these images to the processing unit 705 and/or memory included on the mobile device 700. The images obtained by the camera 761 may comprise video, one or more images that do not form a video, or some combination thereof.

The communication module(s) 732 may provide signals to and receive signals from one or more antenna(s) 765. One of the antenna(s) 765 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 772. In turn, the GPS mechanism 772 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 700 may connect to one or more remote devices. The remote devices may include a personal computer, a server, a router, a network PC, a cell phone, a media playback device, a peer device or other common network node, and typically includes many or all of the elements described above relative to the mobile device 700.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

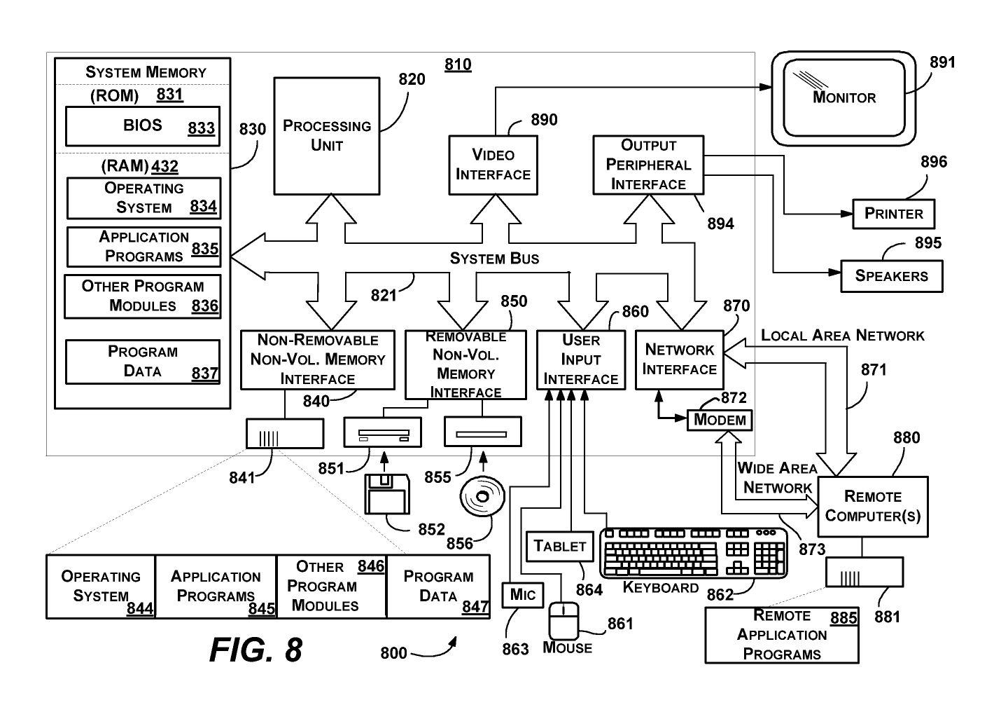

FIG. 8 illustrates an example of a suitable computing and networking environment 800 on which the examples of FIGS. 1-7 may be implemented. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the example operating environment 800.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 8, an example system for implementing various aspects of the invention may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media can be any available media that can be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 810. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, application programs 845, other program modules 846 and program data 847. Note that these components can either be the same as or different from operating system 834, application programs 835, other program modules 836, and program data 837. Operating system 844, application programs 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel can be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are examples and other means of establishing a communications link between the computers may be used.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, obtaining antimalware-related data at a functional adjunct machine, and transferring the antimalware-related data to a malware-compromised machine for use in remediating malware on the compromised machine.

2. The method of claim 1 wherein obtaining the antimalware-related data comprises downloading an application from a marketplace or application store.

3. The method of claim 1 wherein at least part of the antimalware-related data includes antimalware code, and further comprising, executing the antimalware code to scan and remediate the malware on the malware-compromised machine to transform the malware-compromised machine into a clean machine.

4. The method of claim 1 further comprising, updating signatures on the malware-compromised machine with at least part of the antimalware-related data.

5. The method of claim 1 wherein transferring the antimalware-related data to a malware-compromised machine comprises loading code for execution by the malware-compromised machine.

6. The method of claim 1 wherein the malware-compromised machine is compromised by having malware in a storage mechanism thereof, and further comprising, booting the malware-compromised machine from the functional adjunct machine to operate the compromised machine in a non-compromised operational state.

7. The method of claim 6 wherein booting the malware-compromised machine from the functional adjunct machine comprises simulating an input device at the adjunct machine to simulate human interaction with the malware-compromised machine.

8. The method of claim 6 wherein transferring the antimalware-related data to the malware-compromised machine comprises loading antimalware code for execution by the malware-compromised machine while the malware-compromised machine is operating in the non-compromised operational state, and further comprising, executing the antimalware code to scan and remediate the malware on the malware-compromised machine to clean the storage mechanism and transform the malware-compromised machine to a clean machine.

9. The method of claim 8 further comprising, rebooting the clean machine from the storage mechanism after the storage mechanism is cleaned.

10. In a computing environment, a system comprising, a compromised machine containing malware that prevents the compromised machine from cleaning the malware by disabling one or more resources of the compromised machine, a functional adjunct machine coupled to the compromised machine, the functional adjunct machine configured to obtain antimalware-related data on behalf of the malware-compromised machine and to perform one or more actions that use the antimalware-related data as part of a remediation operation that remediates the malware to transform the compromised machine into a clean machine.

11. The system of claim 10 wherein the functional adjunct machine is configured to download an application from a marketplace or application store to obtain the antimalware-related data.

12. The system of claim 10 wherein the functional adjunct machine comprises a mobile device and wherein the compromised machine comprises a personal computer.

13. The system of claim 10 wherein the antimalware-related data comprises executable antimalware code or antimalware signature data, or both executable antimalware code and antimalware signature data.

14. The system of claim 10 wherein the one or more actions that use the antimalware-related data as part of a remediation operation comprises transferring at least part of the antimalware-related data from the functional adjunct machine to the malware-compromised machine.

15. The system of claim 10 wherein the one or more actions that use the antimalware-related data as part of a remediation operation include booting the malware-compromised machine from the functional adjunct machine to operate the compromised machine in a non-compromised operational state.

16. The system of claim 10 wherein the functional adjunct machine is configured to emulate an input device to simulate human interaction with the malware-compromised machine.

17. One or more computer-readable media having computer-executable instructions, which when executed perform steps, comprising:
booting a machine having storage compromised with malware into an offline state with respect to running malware, in which the booting is performed off of a functional adjunct machine that has downloaded boot code and antimalware data;
receiving at least part of the antimalware data while in the offline state from the functional adjunct machine, including antimalware code; and
executing the antimalware code while in the offline state to remediate the malware in the storage.

18. The one or more computer-readable media of claim 17 having further computer-executable instructions comprising, accessing a marketplace or application store to obtain an application associated with the downloaded boot code and the antimalware data.

19. The one or more computer-readable media of claim 17 wherein receiving at least part of the antimalware data while in the offline state from the functional adjunct machine comprises receiving antimalware signature data.

20. The one or more computer-readable media of claim 17 having further computer-executable instructions comprising, rebooting the machine from the storage after remediating the malware in the storage.
